(19) United States
(12) Patent Application Publication
(10) Pub. No.: US 2007/0029691 A1
(43) Pub. Date: Feb. 8, 2007

(54) Compressive molding machine for powder material and method for controlling compressive molding machine for powder material

(75) Inventors: Kazuya Nakamura, Kyoto (JP); Hideyuki Nishimura, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KIKUSUI SEISAKUSHO LTD., Kyoto-shi (JP)

(21) Appl. No.: 11/262,839

(22) Filed: Nov. 1, 2005

(30) Foreign Application Priority Data
Aug. 4, 2005 (JP) P2005-226320

(51) Int. Cl. B29C 43/58; B27N 3/00

(52) U.S. Cl. 264/109; 264/40.4; 425/148; 425/149; 425/345; 425/363

(57) ABSTRACT

In case of administrating weight and thickness of a molded article molded by compressing powder material, if the thickness of the sampled molded article is measured, it takes time to conduct thickness control based on the measured thickness. The compressive molding machine for powder material comprises a powder material compressing means that molds a molded article by compressing powder material filled between members for compression with the members for compression approaching each other to a predetermined distance, a powder material quantity adjusting means that adjusts a quantity of the powder material to be filled, a pressure detecting means that detects compression pressure of the powder material by means of the powder material compressing means, a weight measuring means that samples the molded article and measures weight of the molded article, a powder material quantity controlling means that controls the powder material quantity adjusting means based on a measured value of the weight measured by the weight measuring means, and a compression controlling means that controls the powder material compressing means based on the compression pressure detected by the pressure detecting means so that the compression pressure falls in a predetermined pressure range in order to control thickness of the molded article at least after the powder material controlling means controls the powder material quantity adjusting means at a predetermined number of times, in case that the measured value of the weight corresponds to a predetermined weight range, wherein the powder material compressing means is controlled by the compression controlling means while the powder material quantity adjusting means is controlled by the powder material controlling means.

### BACKGROUND OF THE INVENTION AND RELATED ART STATEMENT

This invention relates to a compressive molding machine for powder material that compresses powder material in order to mold a tablet for medical purpose or the like and a method for controlling the compressive molding machine.

Generally, a molded article such as a tablet or food requires uniform weight and uniform thickness, however, it has been difficult for a machine such as a continuous tableting machine that manufactures multiple molded articles in a short period of time to measure a quantity of the powder material for each molded article prior to molding. Then for a case of a machine wherein a punch is inserted into a die to a predetermined position in order to compress and mold a molded article, attention is focused on that there is a general one-on-one relationship between weight of the molded article and pressure of compressing the powder material for molding the molded article. Based on this relationship, the pressure of compressing the powder material is detected and a quantity of the powder material to be filled into the die is automatically controlled so that the detected pressure becomes standard pressure that has previously been calculated corresponding to the target quantity of the powder material.

A method described in the patent document 1 is known as a method for controlling the weight of the molded article indirectly based on the pressure of compressing the powder material. For a case of this patent document 1, molding pressure is detected at a position where the powder material is compressed before a position where a compressive molding process is finally provided, the weight of the molded article is controlled by controlling an up-and-down movement of a quantity adjusting cam based on the detected molding pressure, the molding pressure at the position where the compressive molding process is finally provided is detected and a distance between a tip of a lower punch on a lower compressive roller and a tip of an upper punch on an upper compressive roller at the position where the compressive molding process is finally provided is changed based on the molding pressure detected at the position where the compressive molding process is finally provided. More specifically, for the case wherein the powder material filled into the die is compressed by a preliminary compressive roller and then a final compressive molding process is conducted by a main compressive roller as described in this patent document 1, the weight of the molded article is controlled by the use of the molding pressure for the preliminary compressive roller and the hardness of the molded article is controlled by the use of the molding pressure for the main compressive roller. (Patent document 1) Japan Patent Official Gazette Number 2941226

Meanwhile, for the case of the above-mentioned patent document 1, the compressive molding pressure by the preliminary compressive roller has to be accurate since the up-and-down movement of the quantity adjusting cam is controlled by the pressure when the preliminary compressive roller is activated. However, the compressive molding pressure by the preliminary compressive roller is generally low and it may vary for each die. As a result, if the up-and-down movement of the quantity adjusting cam is controlled by the detected compressive molding pressure of the preliminary compressive roller, the weight of the molded article may fluctuate. However, it is difficult to detect the compressive molding pressure accurately because the pressure is low.

Furthermore, in case of the above-mentioned patent document 1, since the molding pressure to adjust the weight of the molded article and the molding pressure to control the hardness of the molded article are set differently, a number of sensors as being a detecting element is increased. In addition, since the molding pressure should be detected accurately at multiple portions, a cost for detecting elements is increased.

The present claimed invention intends to solve all of the above problems.

### SUMMARY OF THE INVENTION

In order to attain the object, the present claimed invention has the following arrangement. More specifically, a compressive molding machine for powder material in accordance with the present claimed invention comprises a powder material compressing means that molds a molded article by compressing powder material filled between members for compression with the members for compression approaching each other to a predetermined distance, a powder material quantity adjusting means that adjusts a quantity of the powder material to be filled, a pressure detecting means that detects compression pressure of the powder material by means of the powder material compressing means, a weight measuring means that samples the molded article and measures weight of the molded article, a powder material quantity controlling means that controls the powder material quantity adjusting means based on a measured value of the weight measured by the weight measuring means, and a compression controlling means that controls the powder material compressing means based on the compression pressure detected by the pressure detecting means so that the compression pressure falls in a predetermined pressure range in order to control thickness of the molded article at least after the powder material controlling means controls the powder material quantity adjusting means at a predetermined number of times, in case that the measured value of the weight corresponds to a predetermined weight range, and is characterized by that the powder material compressing means is controlled by the compression controlling means while the powder material quantity adjusting means is controlled by the powder material controlling means.

The present claimed invention is so arranged to control the compression pressure assuming that distance between the members for compression changes in accordance with a change of the compression pressure in case that the change of the weight of the molded article is within the predetermined weight range by making use of a change of the weight of the molded article correlating with the compression pressure at a time of compressing to mold the molded article and a change of the thickness of the molded article correlating with the compression pressure.

In this arrangement, since the powder material quantity adjusting means is controlled by the powder material quantity controlling means and the powder material compressing means is controlled by the compression controlling means in case that the measured value of the weight measured by the weight measuring means corresponds to the predetermined range, the pressure in compressing the powder material is adjusted while the powder material quantity is adjusted. As a result, it is possible to control both the weight and the thickness of the molded article almost at once, thereby to make the molded article satisfy a specification of the weight and the thickness of the molded article quickly.

In order to correspond to excess and deficiency of the weight of the molded article, it is preferable that the predetermined weight range is set in accordance with weight exceeding weight to be a standard and weight less than the weight to be the standard. In addition, in order to make it efficient to measure the weight of the molded article, it is preferable to set the measured value of the weight as total weight of multiple pieces of the sampled molded articles.

In case of controlling the thickness of the molded article by the use of the pressure, in order to prevent excessive control it is preferable that the pressure controlling means controls the powder material compressing means only at a set number of times.

With the above arrangement, in order to improve accuracy in controlling the powder material quantity adjusting means, represented is that an adjusting quantity detecting means to detect the adjusting quantity of the powder material quantity adjusting means is further comprised and the powder material quantity controlling means controls the powder material quantity adjusting means by a correcting quantity calculated based on the powder material weight prior to compression measured based on the adjusting quantity detected by the adjusting quantity detecting means and the weight measured by the weight measuring means.

In addition, in order to improve accuracy in controlling the pressure, represented is that further comprising a correcting means that corrects the predetermined pressure range based on an average value of the pressure detected by the pressure detecting means after completion of controlling the powder material quantity adjusting means by the powder material quantity controlling means.

The present claimed invention is also a method for controlling a compressive molding machine for powder material that molds a molded article by compressing powder material filled between members for compression with the members for compression approaching each other to a predetermined distance, and that comprises processes that compression pressure at a time of compressing the powder material is detected, the molded article is sampled and its weight is measured, a quantity of the powder material to be filled is adjusted based on the measured value of the weight, the compression pressure of the powder material is controlled based on the compression pressure detected so that the compression pressure falls in a predetermined pressure range in order to control thickness of the molded article at least after the quantity of the powder material is controlled at a predetermined number of times, in case that the measured value of the weight corresponds to a predetermined weight range, wherein the compression pressure of the powder material is controlled while the powder material quantity is adjusted.

With this arrangement, it is preferable that the predetermined weight range is set in accordance with weight exceeding weight to be a standard and weight less than the weight to be the standard. In addition, it is preferable that the measured value of the weight is total weight of multiple pieces of the sampled molded articles.

In order to prevent redundant control, it is preferable that the pressure is controlled only at a set number of times.

In order to improve accuracy of controlling the powder material quantity, it is preferable that an adjusting quantity of the powder material quantity is further detected and the powder material quantity is adjusted by a correcting quantity calculated based on the powder material weight prior to compression measured based on the detected adjusting quantity and the measured value of the weight. In addition, in order to improve accuracy of controlling the pressure, it is preferable that the predetermined pressure range is further corrected based on an average value of the pressure detected after completion of adjusting the powder material quantity.

The present claimed invention has the above-mentioned arrangement, and can control the weight of the molded article and the thickness of the molded article controlled by the pressure quickly with controlling the powder material compressing means by the compression controlling means while the powder material quantity adjusting means is controlled by the powder material quantity controlling means. In addition, since there is no need of measuring the thickness of the molded article directly, the arrangement of the measuring means can be simplified, thereby to reduce the manufacturing cost.

### BRIEF DESCRIPTION OF THE DRAWINGS

FIG. 1 is a cross-sectional view of a compressive molding machine for powder material showing one embodiment of the present claimed invention.

FIG. 2 is a pattern diagram of a whole structural view including a control unit in accordance with this embodiment.

FIG. 3 is a plane view showing an arrangement of each principal component relative to a rotary table of the molding machine body of the embodiment.

FIG. 4 is a block diagram showing an arrangement of a control system including the control unit of the embodiment.

FIG. 5 is a graph showing a relationship of set values of weight in accordance with quantity control of the embodiment.

FIG. 6 is a graph showing a relationship of set values of pressure in accordance with thickness control of the embodiment.

FIG. 7 is a flow chart showing a general control process of the embodiment.

FIG. 8 is a flow chart showing a general control process of the embodiment.

### DETAILED DESCRIPTION OF THE PREFERRED EMBODIMENTS

This invention will be described in detail with reference to an embodiment thereof shown in the accompanying drawings.

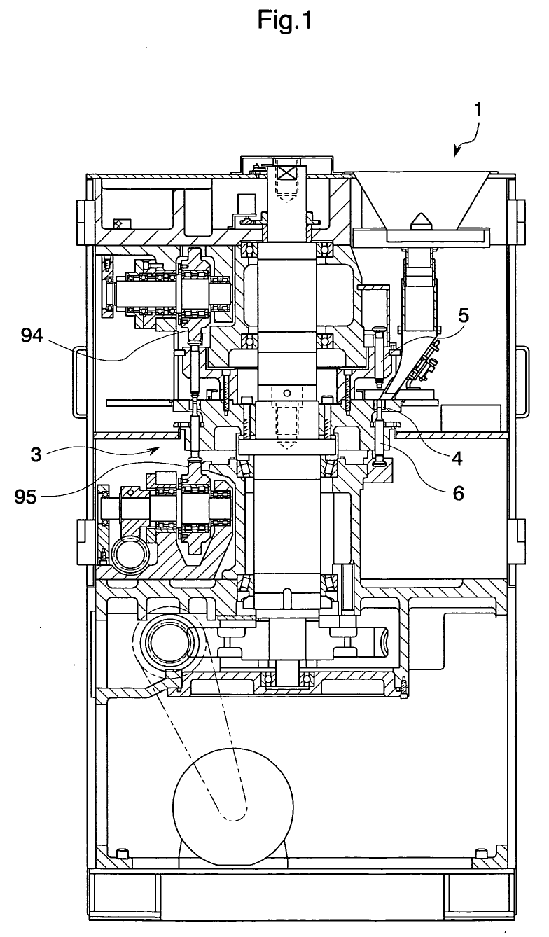

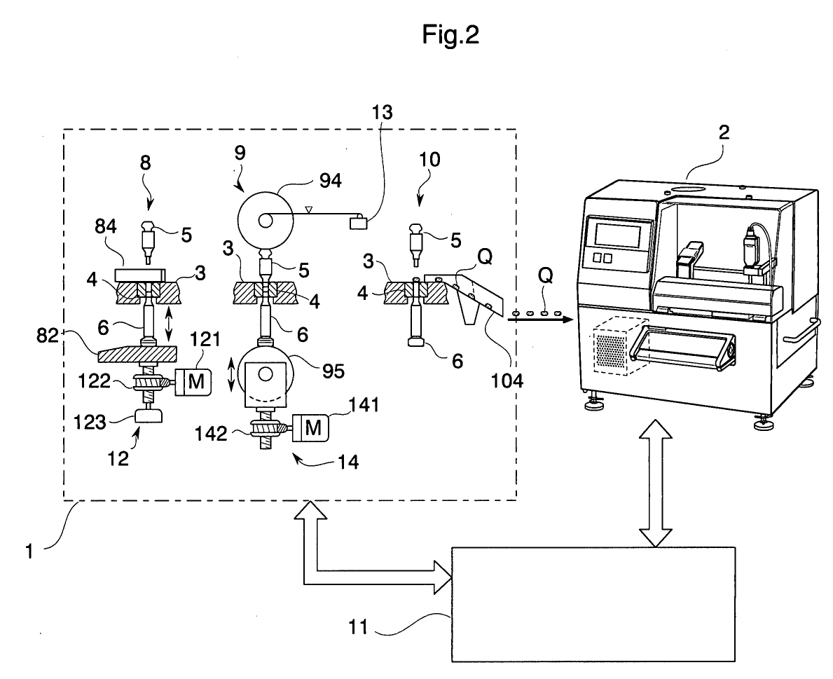

A compressive molding machine for powder material in accordance with this embodiment molds tablets, for example, tablets for medical purpose and comprises, as shown in FIG. 1 and FIG. 2, a molding machine body 1 that actually molds tablets, a measuring unit 2 as being a measuring means that takes a sample of a tablet Q as a molded article that is molded and delivered by the molding machine body 1 and measures a state of the tablet Q, and a control unit 11 that feed-backs the measured results of the measuring unit 2 and controls each condition of the molding machine body 1 for molding the tablet Q.

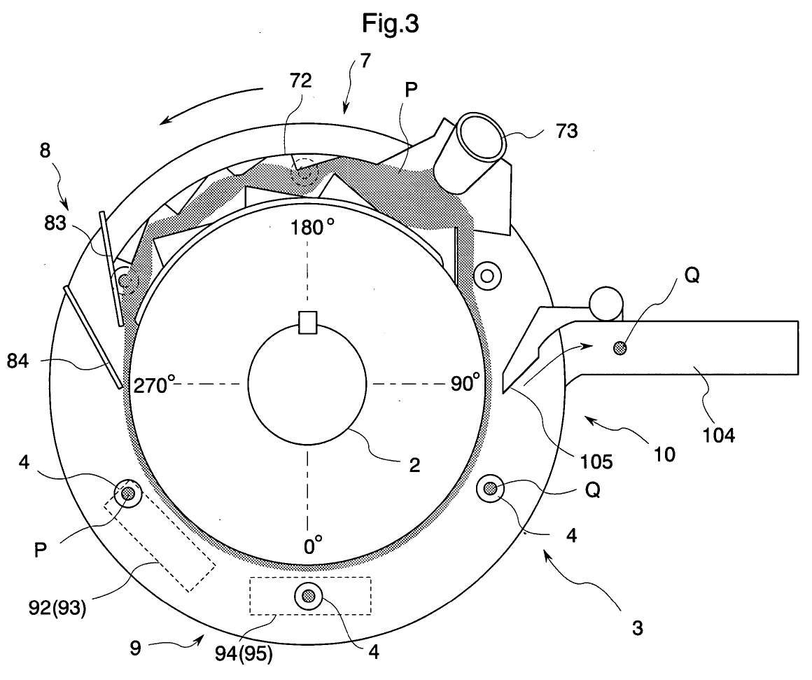

The molding machine body 1 is a rotary type and, as shown in FIG. 3, is so arranged that, multiple cylindrical dies 4 are detachably arranged with a predetermined pitch on a horizontally and rotatably arranged rotary table 3 and upper punches 5 and lower punches 6 as being members for compression are kept in a vertically slidable condition above and below of each die 4 with its axis line coinciding with an axis line of the die 4 so that a tip of the punch 5, 6 can be inserted into an inner circumference of the die 4. Each of the dies 4, the upper punches 5, and the lower punches 6 are arranged to rotate in synchronization with the rotary table 3.

The molding machine body 1 is provided with a powder material filling part 7, a powder material scraping part 8, a compressive molding part 9, and a product ejecting part 10 sequentially along the rotative direction of the rotary table 3.

The powder material filling part 7 introduces powder material (including granulated powder) P that has been supplied on the rotary table 3 into the die 4 through a feed shoe 72 by lowering the lower punch 6. The powder material P is supplied on the rotary table 3 by means of a powder material supplying mechanism 73.

The powder material scraping part 8 raises the lower punch 6 to a predetermined level by means of a quantity adjusting cam 82 and removes the powder material P that has overflowed out of the die 4 due to a rise of the lower punch 6 by means of scrapers 83, 84. In addition, in this embodiment, a powder material quantity adjusting means 12 is arranged to adjust a filled quantity of the powder material P. As shown in FIG. 2, the powder material quantity adjusting means 12 is so arranged to adjust the quantity of the powder material P to be filled into the die 4 by raising or lowering the predetermined position of the lower punch 6. More specifically, the powder material quantity adjusting means 12 comprises an electrical motor 121, a convert mechanism 122 that converts a rotational motion of the electrical motor 121 into a linear motion to change a position of the quantity adjusting cam 82 through a series of gears, and a potentiometer 123 as being a position sensor that detects the position of the quantity adjusting cam 82.

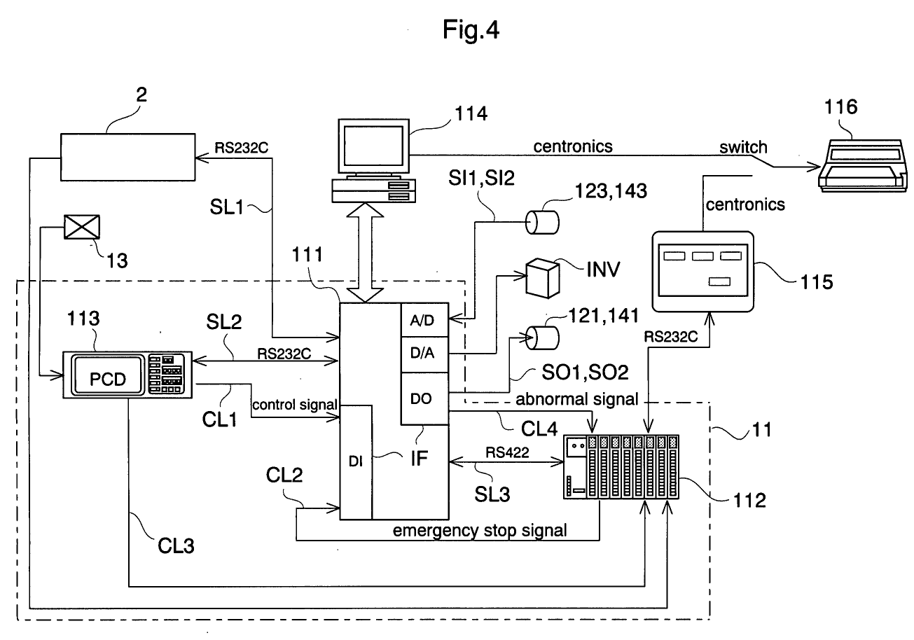

The compressive molding part 9 lowers the upper punch 5 so as to insert a lower tip of the upper punch 5 into the die 4, preliminarily compresses the powder material P filled in the die 4 by the use of upper and lower preliminary compressive rollers 92, 93 with the upper and lower punches 5, 6 each of whose lower and upper tips is inserted into the die 4 pushed from upside and downside to approach each other and compresses the powder material P in the die 4 in a full-scale manner by the use of upper and lower main compressive rollers 94, 95 with the upper and lower punches 5, 6 pushed from upside and downside to approach each other. The compressive molding part 9 corresponds to a powder material compressing means. In addition, in this embodiment, as shown in FIG. 4, a load cell 13 as being a pressure detecting means to detect pressure in case of compressing the powder material P by means of the upper main compressive roller 94 is arranged in conjunction with a rotational axis of the upper main compressive roller 94 and a compression position adjusting means 14 to adjust a vertical position (a longitudinal direction) of the lower main compressive roller 95 is arranged in conjunction with a rotational axis of the lower main compressive roller 95. The compression position adjusting means 14 comprises an electrical motor 141 and a convert mechanism 142 that converts a rotational motion of the electrical motor 141 into a linear motion to change the position of the lower main compressive roller 95 through a series of gears. As mentioned above, in this embodiment, since the compression position adjusting means 14 does not detect compressive pressure of preliminary compression by the upper and lower preliminary compressive rollers 92, 93 and detects compressive pressure of compression by the upper and lower main compressive rollers 94, 95 alone, detecting accuracy of the compressive pressure is not degraded and an arrangement of the compressive molding part 9 can be simplified. As a result, the compression position adjusting means 14 can be applied to a compressive molding machine for powder material that does not conduct preliminary compression.

The product ejecting part 10 raises the upper punch 5 so as to draw the lower tip of the upper punch 5 out of the die 4, urges the lower punch 6 upward so that the tablet Q in the die 4 can be pushed out of the die 4 completely and guides the tablet Q aside by making use of a guiding plate 105 so as to introduce it into a chute 104.

With the above-mentioned arrangement, the molding machine body 1 molds the tablets Q continuously from the powder material P, for example, at every 30 msec by making use of the upper and lower punches 5, 6 and the die 4 with rotating the rotary table 3.

The measuring unit 2 as being a weight measuring means shown in FIG. 4 comprises at least a weight measuring mechanism and a hardness measuring mechanism (not shown in drawings) and can automatically measure weight and hardness of the tablet Q that is introduced by the chute 104 and sampled arbitrarily. A measuring unit disclosed in the Japan utility model patent registration number 3025263 owned by the applicant of the present claimed invention may be used as the measuring unit 2. Fundamentally the measuring unit 2 has a configuration wherein each of the sampled tablets Q is sequentially fed to the weight measuring mechanism and the hardness measuring mechanism arranged on a tablet conveying way, not shown in drawings, by a tablet feeding means. It is so arranged that the measured data is automatically processed and memorized by an internal controller and then the data is displayed on a display unit or output to a printer, or transferred to other device, more concretely, a first controller 111 of the control unit 11 through a serial signal line SL1 that makes use of RS232C. Especially, in this embodiment, it is possible to calculate an average value of the measured data by measuring multiple tablets Q.

The control unit 11 mainly comprises the first controller 111 that is called as a microcomputer and that has a CPU, a memory and an input/output interface IF, a second controller 112 as being a sequencer, and a third controller 113 to which a signal output by the load cell 13 is input and that processes data concerning the pressure, wherein the first controller 111, the second controller 112 and the third controller 113 are so arranged to cooperate by mutually connecting with serial signal lines SL2, SL3 or control signal lines CL1 through CL4. The control unit 11 further comprises various interfaces and can be extended by connecting a personal computer 114, an exclusive use display 115, a printer 116 or a host computer, not shown in drawings.

In this embodiment, a control signal SO1 of the electrical motor 121 that drives the quantity adjusting cam 82 vertically is output from the first controller 111 and a detecting signal SI1 from the potentiometer 123 that detects a quantity of a vertical motion is input so as to form local feedback so that the control unit 11 serves as a powder material quantity controlling means that controls the powder material quantity adjusting means 12. Similarly, a control signal SO2 of the electrical motor 141 that drives the lower main compressive roller 95 vertically is output from the first controller 111 and an output signal from the load cell 13 that detects a quantity of a vertical motion indirectly is input so as to form local feedback so that the control unit 11 serves as a compression controlling means that controls the compression position adjusting means 14.

Next, an operation of the control unit 11 will be explained.

The control unit 11 stores a control program to control a quantity of the powder material P to be filled into the molding machine body 1 and pressure of the upper and lower main compressive rollers 94, 95 together with a data of each set value necessary for control. The control program controls thickness of the tablet Q assuming that the compression pressure is changed by elongation of the upper punch 5 and the lower punch 6 due to temperature change although the weight of the tablet Q as being the molded article is within a predetermined range after initiating a process of compression and molding of the powder material P. More specifically, when the process of compressing and molding the powder material P is initiated, temperature of the upper and lower punches 5, 6 rises due to heat generated by friction resulting from contact between the upper punch 5 and the upper preliminary or main compressive roller 92 or 94, heat generated by friction resulting from contact between the lower punch 6 and the lower preliminary or main compressive roller 93 or 95, and heat resulting from compression molding of the powder material P, resulting in the upper punch 5 and the lower punch 6 being elongated. Therefore, in case the filled quantity of the powder material P, namely the weight of the tablet Q corresponds to (is included in) the predetermined weight range, a position of the lower main compressive roller 95 is adjusted in order to adjust the thickness of the tablet Q based on a fact that the compression pressure does not change depending on the filled quantity of the powder material P but changes depending on a distance between the lower tip of the upper punch 5 and the upper tip of the lower punch 6.

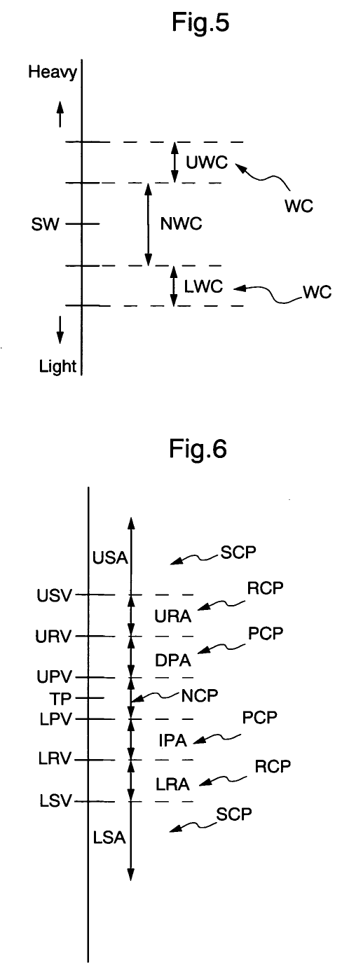

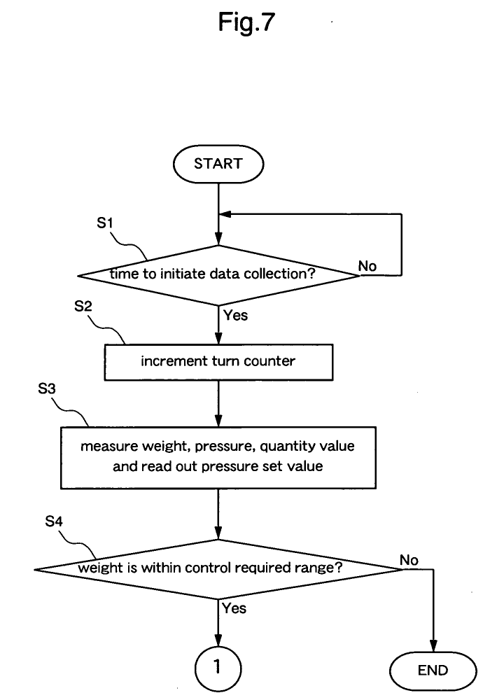

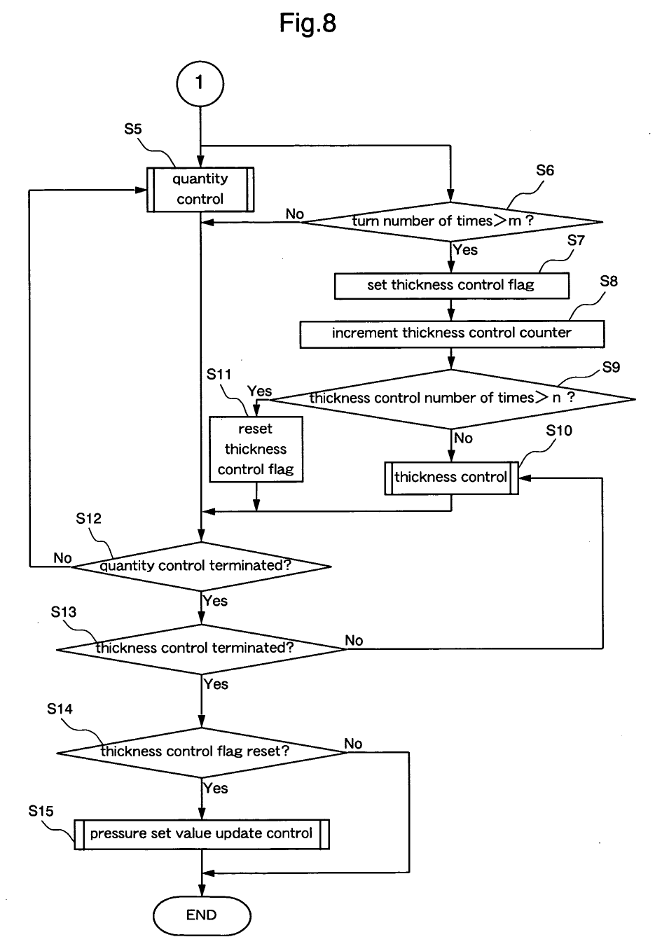

Next, as a data for control that accompanies the control program, standard weight SW of the tablet Q, a non-control range NWC and a control required range WC (shown in FIG. 5) each of which is set based on the standard weight SW, a target pressure set value TP as being pressure to be a standard for compression molding, and a compression control range (shown in FIG. 6) to be a judge standard of a quality of the tablet Q are memorized in the control unit 11.

The standard weight SW is a value to be a standard of the tablet Q to be molded. The non-control range NWC shown in FIG. 5 specifies a weight range of the tablet Q that requires no control of the quantity (the weight) to be described later and is set by a value less than the standard weight SW and a value more than the standard weight SW, for example, a value less than the standard weight SW by 5% and a value more than the standard weight SW by 5%. In this embodiment, the standard weight SW is set to correspond to not weight of one piece of the tablet Q, but total weight of a predetermined number of pieces of the tablets Q. The control required range WC specifies a weight range of the tablet Q that requires quantity control and is set based on the standard weight SW and the non-control range NWC. More concretely, the control required range WC is set to be a range wherein the non-control range NWC is removed from a weight range specified by a value less than the standard weight SW by 10% and a value more than the standard weight SW by 10%. An area locating upper than the non-control range NWC is set as an upper control required range UWC and an area locating lower than the non-control range NWC is set as a lower control required range LWC. The weight is measured within a weight range between a value more than the standard weight SW by 50% and a value less than the standard weight SW by 50%.

The compression control range is set to execute control in three different stages with a center being the target pressure set value TP. More specifically, the compression control range comprises an increase and decrease control range part PCP to determine execution of thickness control to be described later with a center being a standard pressure set value, an elimination control range part RCP that is set at areas above and below the increase and decrease control range part PCP and that determines execution of elimination control of the tablet Q, a halt control range part SCP that is set at areas above and below the elimination control range part RCP and that determines halt of operating the compressive molding machine for powder material, and a non-control range part NCP.

The increase and decrease control range part PCP comprises a depressurizing control area DPA that is greater than or equal to an upper limit depressurizing pressure set value UPV and that is less than an upper limit elimination pressure set value URV, and a pressurizing control area IPA that is less than or equal to a lower limit pressurizing pressure set value LPV and that is greater than a lower limit elimination pressure set value LRV.

The elimination control range part RCP comprises an upper elimination area URA that is greater than or equal to the upper limit elimination pressure set value URV and that is less than an upper limit halt pressure set value USV, and a lower elimination area LRA that is less than or equal to the lower limit pressurizing pressure set value LRV and that is greater than a lower limit halt pressure set value LSV.

The halt control range part SCP comprises an upper halt area USA that is greater than or equal to the upper limit halt pressure set value USV, and a lower halt area LSA that is less than or equal to the lower limit halt pressure set value LSV. The halt control range part SCP is not for thickness controlling to be described later, but for halting an operation of the compressive molding machine for powder material compulsorily by determining that measured pressure shows an abnormal value. As a result, determination whether or not that the measured pressure is a value included in the halt control range part SCP is continuously executed after the pressure measurement is initiated independent from the thickness control and the quantity control.

The non-control range part NCP is an area that is greater than the lower limit pressurizing pressure set value LPV and that is less than the upper limit depressurizing pressure set value UPV. The target pressure set value TP is calculated by adding the upper limit depressurizing pressure set value UPV to the lower limit pressurizing pressure set value LPV and then dividing its sum into two.

First, in a step S1, whether or not it is data collection initiating time is determined. More specifically, the control program to execute the weight control and the thickness (compressive pressure) control is repeatedly executed starting from an initiation of operating the compressive molding machine for powder material at predetermined intervals. As a result, the time when the control program is executed is set at every predetermined time. The measurement of the weight and the measurement of the pressure are not conducted in synchronization with an initiation of the control program but conducted continuously in synchronization with an operating state of the molding machine body 1 in the measuring unit 2 (measurement of the weight) and the third controller 113 (measurement of the pressure).

In the step S1, in case of determining that it is the data collecting time, a turn counter is incremented by one in a step S2. The turn counter counts a time when the control program is executed as one turn, and may be formed by the use of software in the control unit 11. The turn counter memorizes a number of counted turns even though the compressive molding machine for powder material is powered off and will not be reset without an operation by an operator. This is to prevent the compressive molding machine for powder material from conducting a useless control after a state that the compressive molding machine is powered off such as an emergency stop for a short time. A latest value of the weight and the pressure is read by the first controller 111 and used in the quantity control and the thickness control. In this embodiment, the measured weight is weight of the predetermined pieces of the tablets Q and the measured pressure is pressure on a pair of dies 5, 6 in the latest main compressive roller 94, 95.

In a step S3, the latest values of the quantity value, the pressure and the weight measured and stored at a time of the data collecting initiation time are read out and each of the pressure set value that specifies the increase and decrease control range part PCP set at this time is read out. Since the quantity value corresponds to the filled quantity of the powder material P and is determined by a position of the upper tip of the lower punch 6 in the die 4, the quantity value is expressed by a position data of the quantity adjusting cam 82. As a result, the quantity value is detected by the potentiometer 123. The pressure is measured by the control unit 11 based on an output signal from the load cell 13, stored in the control unit 11, and then read out. The weight is measured by sampling a predetermined number, for example, 10 pieces of the tablets Q and then a total weight the sampled tablets Q is measured by the measuring unit 2. The weight measured by the measuring unit 2 is stored in the measuring unit 2 and read out by the control unit 11 through the serial signal line SL1. The measured quantity value, pressure and weight are stored in the control unit 11.

In a step S4, it is determined whether the measured weight is included in the non-control range NWC or in the control required range WC. More specifically, whether or not the weight control and the thickness control of the tablet Q are necessary is determined by determining the measured weight of the tablet Q. In case it is not included in the control required range WC, execution of the control program at this turn is terminated. In case it is included in the control required range WC, at least the quantity control is executed in a step S5.

The quantity control calculates a correction quantity value based on the standard weight SW, the measured quantity value and the measured weight, and controls the quantity adjusting cam 82 until the quantity becomes the calculated correction quantity value. More specifically, in case that the calculated correction quantity value is less than the present quantity value, the control unit 11 outputs the control signal to the powder material quantity adjusting means 12 and raises the quantity adjusting cam 82 so as to decrease the quantity value. In case that the calculated correction quantity is greater than the present quantity value, the quantity value is controlled to increase by lowering the quantity adjusting cam 82. The correction quantity value is calculated by the following expression.
correction quantity value=present quantity value×(standard weight/present weight) (1)

In the expression (1), each of the present quantity value and the present weight is the latest value of the quantity value and the weight read out in the step S3.

In a step S6, it is determined whether or not the number of the counted turns of the turn counter is greater than a thickness control determine value m. The thickness control determining value m is set as, for example, four. In other words, the determination is to detect a state wherein the compressive molding machine for powder material is operated and its inside temperature is approaching to predetermined temperature after the control program is executed four times and the quantity control is conducted four times.

In the step S6, in case it is determined that the number of counted turns is greater than the thickness control determine value m, a thickness control flag is set (=1) in a step S7. Then a thickness control counter that is arranged in addition to the turn counter is incremented in a step S8. The thickness control counter is to count a number of times that the thickness control is executed and to keep the number of times until it is reset by the operator after the thickness control is conducted at a predetermined number of times.

In a step S9, it is determined whether or not the number of times of the thickness control counted by the thickness control counter exceeds a predetermined number of times n. The predetermined number of times n is set as, for example, seven. In case that the number of times of the thickness control is less than or equal to the predetermined number of times n, the thickness control is conducted in a step S10. In case that the number of times of the thickness control exceeds the predetermined number of times n, the thickness control flag is reset (=0) in a step S11 without conducting the thickness control.

The thickness control in the step S10 is conducted along with conducting the quantity control in the step S5. The third controller 113 determines whether or not the thickness control is to be conducted based on the pressure at the time and the pressure set value read out in the step S3. More specifically, in case that the measured pressure is included in the elimination control range part RCP and the increase and decrease control range part PCP, the position of the lower main compressive roller 95 is adjusted so as to control the pressure.

More specifically, in case that the measured pressure is included in the depressurizing control area DPA and the upper elimination area URA, the lower main compressive roller 95 is controlled to lower its position so as to decrease the pressure. On the contrary, in case that the measured pressure is included in the pressurizing control area IPA and the lower elimination area LRA, the lower main compressive roller 95 is controlled to raise its position so as to increase the pressure.

In case that the measured pressure is included in the elimination control range part RCP, the tablet Q is eliminated by controlling an elimination mechanism, not shown in drawings, along with conducting the thickness control. In addition, in case that the measured pressure is included in the non-control range part NCP, the measured pressure is determined to be approximate to the standard pressure set value TP and no thickness control is conducted.

Next, in a step S12 it is determined whether or not the quantity control is terminated. The determination whether or not the quantity control is terminated is conducted by detecting that the quantity adjusting cam 82 is moved by an amount corresponding with the correction quantity value. More specifically, in case that the quantity value corresponding to the position of the quantity adjusting cam 82 measured after quantity correction based on an output signal of the potentiometer 123 coincides with the correction quantity value, it is determined that the quantity control is terminated.

In a step S13, whether or not the thickness control is terminated is determined by detecting that the measured pressure is included in the non-control range part NCP. More concretely, it is detected whether or not a control signal that shows less than or equal to the upper limit depressurizing pressure set value UPV and that shows greater than or equal to the lower limit pressurizing pressure set value LPV is output to the first controller 111 from the third controller 113 of the control unit 11 through the control signal line CL1. In case that the control signal is not output, it is determined that the thickness control is terminated. If the turn number of times counted by the turn counter is less than or equal to the thickness control determine value m, the thickness control itself is not conducted, resulting in no output of the control signal.

In a step S14, a state of the thickness control flag is verified. More specifically, it is determined whether or not the thickness control flag is set. In case it is determined that the thickness control flag is set, the control is terminated. In case it is determined that the thickness control flag is reset, proceed to a step S15. In the step S15, update control is conducted to each pressure that specifies a pressure control range.

The update control of the pressure control range is to update each pressure set value of the pressure control range read out in the step S3 based on the pressure (present pressure) measured prior to the quantity control conducted at this time and an average value of the pressure (average pressure) measured after the quantity correction. More concretely, first the average value of the pressure measured after the quantity control is conducted is computed in the third controller 113 and a difference obtained from subtracting the target pressure from the computed average pressure is added to the present pressure. The computed result obtained from the above-mentioned addition is set as the control pressure. Next, a shift quantity to update the set value is computed by subtracting the target pressure from the control pressure. After the shift quantity is computed, the shift quantity is added to or subtracted from each of the upper limit depressurizing pressure set value UPV, the lower limit pressurizing pressure set value LPV, the upper limit elimination pressure set value URV, the lower limit elimination pressure set value LRV, the upper limit halt pressure set value USV, and the lower limit halt pressure set value LSV so as to set a new set value, namely the set value is updated. In case that the control pressure is lower than the target pressure TP, the shift quantity is subtracted from each set value. In case that the control pressure is higher than the target pressure TP, the shift quantity is added to each set value.

In this arrangement, explained will be control in case that the turn number of times is less than or equal to a thickness control determine value m while the compressive molding machine for powder material is operated. First, at a time to initiate data collection, the step S1 through the step S4 are conducted. In case that the weight of the measured tablet Q is determined to be out of the control required range, the control program is terminated without conducting the quantity control, the thickness control and the pressure set value update control. In other words, in this case, since the weight of the sampled tablet Q is included in the non-control range and the weight of the tablet Q is almost within a measurement error tolerance range from the standard weight, the quantity control is not conducted.

If it is determined that the weight of the measured tablet Q is within the control required range in the step S4, the quantity control is conducted (step S5), and the thickness control is not conducted because the turn number of times is less than or equal to the thickness control determine value (determined as “No” in the step S6). The quantity control is, as mentioned above, to adjust the quantity adjusting cam 82 in accordance with the weight of the sampled and measured tablet Q. Then if it is determined that the quantity control is terminated (step S12), the pressure control value update control is conducted. In this case, since the turn number of times does not reach the thickness control determining value, the thickness control is not conducted. Then it is determined as “Yes” in the step S13 and the step S14 respectively, and the pressure set value update control is conducted in the step S15.

The pressure set value update control is conducted under the condition that both the quantity control is terminated and the thickness control flag is reset. As a result, the pressure set value update control is not conducted while the quantity control is conducted. In addition, the pressure set value update control is not conducted while the thickness control flag is set, in other words, the number of times of the thickness control does not reach the predetermined number of times n even though the quantity control is terminated.

As a result, each pressure set value is updated based on the pressure after adjusted by conducting the quantity control. Then each pressure set value reflects the filling quantity of the powder material P changed by the quantity control and improves an accuracy of the thickness control conducted alongside with the quantity control.

The thickness control is conducted under the condition that the weight of the measured tablet Q is within the control required range (determined as “Yes” in the step S4), that the turn number of times counted by the turn counter is greater than the thickness control determine value m (determined as “Yes” in the step S6), and that the thickness control number of times counted by the thickness control counter is less than or equal to the predetermined number of times n (determined as “No” in the step S9).

Since the thickness control, which is conducted alongside with the quantity control, namely, which outputs the control signal to conduct the quantity control and actually drives the powder material quantity adjusting means 12 with the control signal, and which is conducted while the powder material quantity adjusting means 12 is activated, is conducted when the above-mentioned condition is satisfied, neither the quantity control nor the thickness control is conducted if the weight of the measured tablet Q is out of the determining range even though the control program wherein the turn number of times is greater than the thickness control determine value m is executed. In addition, the thickness control is not further conducted in case that the number of times to conduct the thickness control exceeds the predetermined number of times n (determined as “No” in the step S9). More specifically, the thickness control is conducted after time relating to execution time of the control program passes from time when the control program is executed and the number of times to execute the control program is specified by the predetermined number of times n. As a result, excessive control of the thickness of the tablet Q is restrained.

As mentioned above, in case that the weight of the tablet Q is to be controlled, since the quantity control is conducted and then the pressure set value is updated before the thickness control is executed, namely, before the thickness control flag is set, it is possible to change the pressure set value in accordance with the change of the length of at least the upper and the lower punches 5, 6 due to temperature change. This makes it possible to improve control accuracy in controlling the thickness of the tablet Q.

In addition, in case that the weight of the tablet Q is the weight that requires control, namely, is not the weight corresponding to the non-control range, the quantity control is conducted so as to control the quantity of the powder material to be filled into the die is controlled while the thickness control is conducted alongside with the quantity control, which makes it possible to converge the weight and the thickness of the tablet Q to a desired weight and thickness quickly. In addition, since the thickness control is conducted based on the latest pressure measured without measuring the thickness of the tablet Q, it is possible to eliminate time delay from time when the tablet Q is sampled to time the measurement of thickness is terminated, thereby to reduce time to be required for control.

In the above-mentioned embodiment, ten pieces of the tablets Q are sampled, each weight of the tablets Q is measured and the total sum of each weight is set as the weight for the quantity control, however, it may be weight of the tablet Q measured individually or may be an average value of multiple pieces of the tablets Q.

In addition, the step S14 and the step S15 in the above embodiment may be omitted. In this case, the compression control range is made smaller than that of the above-mentioned embodiment and the thickness control is conducted to make the pressure to be detected at a center of the pressure control range on a steady basis in compliance with a change of the molding pressure in accordance with a change of a length of the punch.

The other arrangement of the component is not limited to the above-mentioned embodiment and there may be various modifications without departing from the spirit of the present claimed invention.

1. A compressive molding machine for powder material comprising
a powder material compressing means that molds a molded article by compressing powder material filled between members for compression with the members for compression approaching each other to a predetermined distance,
a powder material quantity adjusting means that adjusts a quantity of the powder material to be filled,
a pressure detecting means that detects compression pressure of the powder material by means of the powder material compressing means,
a weight measuring means that samples the molded article and measures weight of the molded article,
a powder material quantity controlling means that controls the powder material quantity adjusting means based on a measured value of the weight measured by the weight measuring means, and
a compression controlling means that controls the powder material compressing means based on the compression pressure detected by the pressure detecting means so that the compression pressure falls in a predetermined pressure range in order to control thickness of the molded article at least after the powder material controlling means controls the powder material quantity adjusting means at a predetermined number of times, in case that the measured value of the weight corresponds to a predetermined weight range,
wherein the powder material compressing means is controlled by the compression controlling means while the powder material quantity adjusting means is controlled by the powder material controlling means.

2. The compressive molding machine for powder material described in claim 1, wherein the predetermined weight range is set in accordance with weight exceeding weight to be a standard and weight less than the weight to be the standard.

3. The compressive molding machine for powder material described in claim 1, wherein the measured value of the weight is total weight of multiple pieces of the sampled molded articles.

4. The compressive molding machine for powder material described in claim 1, wherein the pressure controlling means controls the powder material compressing means only at a set number of times.

5. The compressive molding machine for powder material described in claim 1, wherein an adjusting quantity detecting means to detect the adjusting quantity of the powder material quantity adjusting means is further comprised, and the powder material quantity controlling means controls the powder material quantity adjusting means by a correcting quantity calculated based on the powder material weight prior to compression measured based on the adjusting quantity detected by the adjusting quantity detecting means and the weight measured by the weight measuring means.

6. The compressive molding machine for powder material described in claim 1, wherein further comprising a correcting means to correct the predetermined pressure range based on an average value of the pressure detected by the pressure detecting means after completion of controlling the powder material quantity adjusting means by the powder material quantity controlling means.

7. A method for controlling a compressive molding machine for powder material that molds a molded article by compressing powder material filled between members for compression with the members for compression approaching each other to a predetermined distance, comprising processes that;
compression pressure at a time of compressing the powder material is detected,
the molded article is sampled and its weight is measured, a quantity of the powder material to be filled is adjusted based on the measured value of the weight, and
the compression pressure of the powder material is controlled based on the compression pressure detected so that the compression pressure falls in a predetermined pressure range in order to control thickness of the molded article at least after the quantity of the powder material is controlled at a predetermined number of times, in case that the measured value of the weight corresponds to a predetermined weight range, wherein
the compression pressure of the powder material is controlled while the powder material quantity is adjusted.

8. The method for controlling the compressive molding machine for powder material described in claim 7, wherein the predetermined weight range is set in accordance with weight exceeding weight to be a standard and weight less than the weight to be the standard.

9. The method for controlling the compressive molding machine for powder material described in claim 7, wherein the measured value of the weight is total weight of multiple pieces of the sampled molded articles.

10. The method for controlling the compressive molding machine for powder material described in claim 7, wherein the pressure is controlled only at a set number of times.

11. The method for controlling the compressive molding machine for powder material described in claim 7, wherein an adjusting quantity of the powder material quantity is further detected and the powder material quantity is adjusted by a correcting quantity calculated based on the powder material weight prior to compression measured based on the detected adjusting quantity and the measured value of the weight.

12. The method for controlling the compressive molding machine for powder material described in claim 7, wherein the predetermined pressure range is further corrected based on an average value of the pressure detected after completion of adjusting the powder material quantity.
